(19) United States
(12) Patent Application Publication
(10) Pub. No.: US 2022/0209693 A1
(43) Pub. Date: Jun. 30, 2022

(54) MOTOR UNIT

(71) Applicant: Global Mixed-mode Technology Inc., Hsin-Chu (TW)

(72) Inventor: Chia-Tai Yang, Hsinchu County (TW)

(21) Appl. No.: 17/135,937

(22) Filed: Dec. 28, 2020

(51) Int. Cl. H02P 6/18; H02P 21/16

(52) U.S. Cl. CPC H02P 6/188; H02P 21/16

(57) ABSTRACT

A motor unit comprises a switch circuit and a control unit. The switch circuit comprises a first terminal and a second terminal, where the switch circuit is coupled to a motor for driving the motor. The first terminal has a first voltage signal. The control unit generates a plurality of control signals to control the switch circuit. When the first terminal is in a floating state, the motor unit utilizes left-right asymmetry of the first voltage signal to judge whether the motor is in a forward rotation state or not. The motor unit further comprises the motor, where the motor comprises a rotor, a silicon steel plate, and a coil. The silicon steel plate has an asymmetrical structure.

### BACKGROUND OF THE INVENTION

### 1. Field of the Invention

The present invention relates to a motor unit, and more particularly, to a motor unit which is capable of judging whether a rotation direction of a motor is correct or not.

### 2. Description of the Prior Art

Conventionally, there are two driving methods for driving a motor. The first driving method uses the Hall sensor for switching phases, so as to drive the three-phase motor. The second driving method does not use the Hall sensor to drive the motor. The Hall sensor is affected by the external environment easily, such that the detecting accuracy is decreased. Besides, the installation of the Hall sensor results in an increase of the volume and the cost of the system. Therefore, the sensorless driving method is provided for solving the above problems.

U.S. Pat. No. 8,248,011 discloses a driving method and driving device of a two-phase brushless motor. The two-phase brushless motor includes a rotor, a first coil, and a second coil. The method includes activating the two-phase brushless motor, detecting an output voltage of a passive coil among the first coil and the second coil to judge whether the rotor rotates according to a default rotational direction or not. However, the invention is designed for the two-phase brushless motor. Thus, the method and device cannot be applied to a single-phase motor.

### SUMMARY OF THE INVENTION

According to the present invention, a motor unit which may be applied to a single-phase sensorless motor is provided. The motor unit comprises a motor, a switch circuit, a control unit, and a detecting unit. The switch circuit includes a first transistor, a second transistor, a third transistor, a fourth transistor, a first terminal, and a second terminal, where the switch circuit is coupled to the motor for driving the motor. The first terminal has a first voltage signal. The second terminal has a second voltage signal. The motor is coupled to the first terminal and the second terminal. The first transistor is coupled to a voltage source and the first terminal while the second transistor is coupled to the first terminal and a ground. The third transistor is coupled to the voltage source and the second terminal while the fourth transistor is coupled to the second terminal and the ground. Each of the first transistor, the second transistor, the third transistor, and the fourth transistor may be respectively a p-type MOSFET or an n-type MOSFET.

The control unit generates a first control signal, a second control signal, a third control signal, and a fourth control signal so as to respectively control the ON/OFF states of the first transistor, the second transistor, the third transistor, and the fourth transistor. The detecting unit is coupled to the first terminal and the second terminal for detecting the first voltage signal and the second voltage signal, so as to generate a detecting signal to the control unit.

The motor comprises a rotor, a silicon steel plate, and a coil, where the silicon steel plate has an asymmetrical structure. The rotor may be divided into two magnetic poles N and two magnetic poles S to switch phases. The silicon steel plate comprises a first pole body, a second pole body, a third pole body, a fourth pole body, a first pole shoe, a second pole shoe, a third pole shoe, and a fourth pole shoe. The first pole shoe is coupled to a terminal of the first pole body for increasing the magnetically conductive area of the silicon steel plate. The second pole shoe is coupled to a terminal of the second pole body for increasing the magnetically conductive area of the silicon steel plate. The third pole shoe is coupled to a terminal of the third pole body for increasing the magnetically conductive area of the silicon steel plate. The fourth pole shoe is coupled to a terminal of the fourth pole body for increasing the magnetically conductive area of the silicon steel plate. Each of the first pole shoe, the second pole shoe, the third pole shoe, and the fourth pole shoe may form an ax shape, where the ax shape is an asymmetrical pattern. That is to say, each of the first pole shoe, the second pole shoe, the third pole shoe, and the fourth pole shoe forms an asymmetrical shape. The coil may surround the first pole body, the second pole body, the third pole body, and the fourth pole body for driving the rotor based on the magnetic induction resulting in the variation of the magnetic field.

When the motor unit installs the asymmetrical silicon steel plate, it results that the back electromotive force signal sensed by the first terminal or the second terminal is left-right asymmetrical, so as to judge whether the motor is in a forward rotation state or a reverse rotation state. When the first terminal is in a floating state and the second terminal is at a low level, the first voltage signal shows left-right asymmetry with respect to a time point. The first voltage signal has a right-side slope, a left-side slope, a right-side area, and a left-side area. When the motor is in the forward rotation state, the absolute value of the right-side slope is greater than the absolute value of the left-side slope and the right-side area is greater than the left-side area. On the contrary, when the motor is in the reverse rotation state, the absolute value of the right-side slope is less than the absolute value of the left-side slope and the right-side area is less than the left-side area. The detecting unit may generate the detecting signal to inform the control unit that the motor is in the forward rotation state or the reverse rotation state by detecting the first voltage signal and utilizing left-right asymmetry characteristics of the first voltage signal. When the detected rotation direction is different from a predetermined rotation direction, the motor unit can be aware that the motor is in a wrong rotation direction state. Thus, the motor unit may judge whether the rotation direction of the motor is correct or not based on left-right asymmetry characteristics of a back electromotive force signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing a motor unit according to one embodiment of the present invention;

FIG. 2 is a schematic diagram showing a motor according to one embodiment of the present invention; and

FIG. 3 is a timing chart according to one embodiment of the present invention.

### DETAILED DESCRIPTION

Preferred embodiments according to the present invention will be described in detail with reference to the drawings.

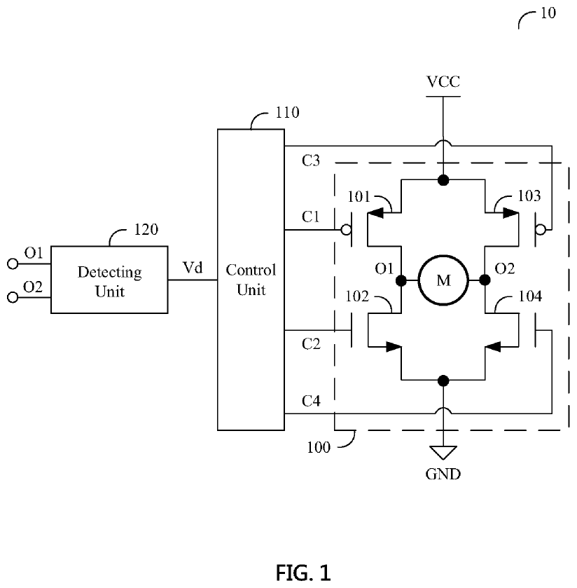

FIG. 1 is a schematic diagram showing a motor unit 10 according to one embodiment of the present invention. The motor unit 10 comprises a motor M, a switch circuit 100, a control unit 110, and a detecting unit 120. The switch circuit 100 includes a first transistor 101, a second transistor 102, a third transistor 103, a fourth transistor 104, a first terminal O1, and a second terminal O2, where the switch circuit 100 is coupled to the motor M for driving the motor M. The first terminal O1 has a first voltage signal VO1. The second terminal O2 has a second voltage signal VO2. The motor M is coupled to the first terminal O1 and the second terminal O2. The first transistor 101 is coupled to a voltage source VCC and the first terminal O1 while the second transistor 102 is coupled to the first terminal O1 and a ground GND. The third transistor 103 is coupled to the voltage source VCC and the second terminal O2 while the fourth transistor 104 is coupled to the second terminal O2 and the ground GND. Each of the first transistor 101, the second transistor 102, the third transistor 103, and the fourth transistor 104 may be respectively a p-type MOSFET or an n-type MOSFET. As shown in FIG. 1, each of the first transistor 101 and the third transistor 103 may be a p-type MOSFET, while each of the second transistor 102 and the fourth transistor 104 may be an n-type MOSFET.

The control unit 110 generates a first control signal C1, a second control signal C2, a third control signal C3, and a fourth control signal C4 so as to respectively control the ON/OFF states of the first transistor 101, the second transistor 102, the third transistor 103, and the fourth transistor 104. The control unit 110 operates alternatively in a first driving mode and a second driving mode, so as to supply the electric energy to the motor M. In the first driving mode, the control unit 110 turns on the first transistor 101 and the fourth transistor 104 by controlling the first control signal C1 and the fourth control signal C4. At this moment the current flows sequentially from the voltage source VCC to the first transistor 101, the motor M, and the fourth transistor 104 for supplying the electric energy to the motor M. In the second driving mode, the control unit 110 turns on the second transistor 102 and the third transistor 103 by controlling the second control signal C2 and the third control signal C3. At this moment the current flows sequentially from the voltage source VCC to the third transistor 103, the motor M, and the second transistor 102 for supplying the electric energy to the motor M. By operating alternatively between the first driving mode and the second driving mode, the motor M can be rotated normally as a result. The detecting unit 120 is coupled to the first terminal O1 and the second terminal O2 for detecting the first voltage signal VO1 and the second voltage signal VO2, so as to generate a detecting signal Vd to the control unit 110.

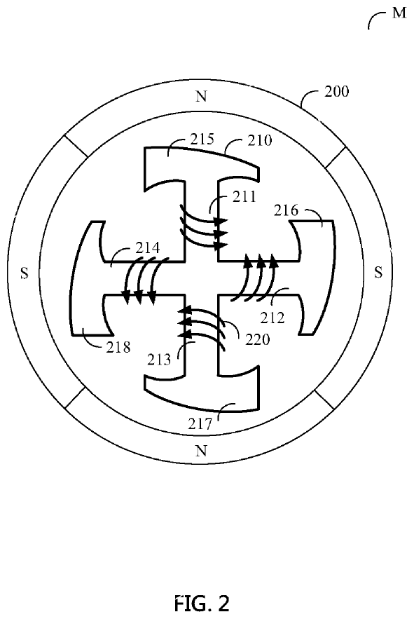

FIG. 2 is a schematic diagram showing the motor M according to one embodiment of the present invention. The motor M comprises a rotor 200, a silicon steel plate 210, and a coil 220, where the silicon steel plate 210 has an asymmetrical structure. The rotor 200 may be divided into two magnetic poles N and two magnetic poles S to switch phases. The silicon steel plate 210 comprises a first pole body 211, a second pole body 212, a third pole body 213, a fourth pole body 214, a first pole shoe 215, a second pole shoe 216, a third pole shoe 217, and a fourth pole shoe 218. The first pole shoe 215 is coupled to a terminal of the first pole body 211 for increasing the magnetically conductive area of the silicon steel plate 210. The second pole shoe 216 is coupled to a terminal of the second pole body 212 for increasing the magnetically conductive area of the silicon steel plate 210. The third pole shoe 217 is coupled to a terminal of the third pole body 213 for increasing the magnetically conductive area of the silicon steel plate 210. The fourth pole shoe 218 is coupled to a terminal of the fourth pole body 214 for increasing the magnetically conductive area of the silicon steel plate 210. Each of the first pole shoe 215, the second pole shoe 216, the third pole shoe 217, and the fourth pole shoe 218 may form an ax shape, where the ax shape is an asymmetrical pattern. That is to say, each of the first pole shoe 215, the second pole shoe 216, the third pole shoe 217, and the fourth pole shoe 218 forms an asymmetrical shape. The coil 220 may surround the first pole body 211, the second pole body 212, the third pole body 213, and the fourth pole body 214 for driving the rotor 200 based on the magnetic induction resulting in the variation of the magnetic field.

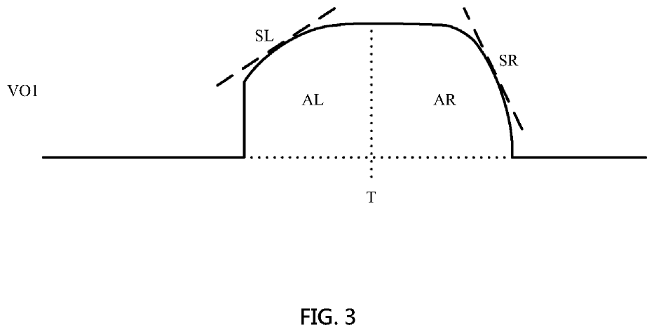

More specifically, when the motor unit 10 installs the asymmetrical silicon steel plate 210, it results that the back electromotive force signal sensed by the first terminal O1 or the second terminal O2 is left-right asymmetrical, so as to judge whether the motor M is in a forward rotation state or a reverse rotation state. FIG. 3 is a timing chart according to one embodiment of the present invention. When the first terminal O1 is in a floating state and the second terminal O2 is at a low level, the first voltage signal VO1 shows left-right asymmetry with respect to a time point T. The first voltage signal VO1 has a right-side slope SR, a left-side slope SL, a right-side area AR, and a left-side area AL. As shown in FIG. 3, when the motor M is in the forward rotation state, the absolute value of the right-side slope SR is greater than the absolute value of the left-side slope SL and the right-side area AR is greater than the left-side area AL. On the contrary, when the motor M is in the reverse rotation state, the absolute value of the right-side slope SR is less than the absolute value of the left-side slope SL and the right-side area AR is less than the left-side area AL. The detecting unit 120 may generate the detecting signal Vd to inform the control unit 110 that the motor M is in the forward rotation state or the reverse rotation state by detecting the first voltage signal VO1 and utilizing left-right asymmetry characteristics of the first voltage signal VO1. When the detected rotation direction is different from a predetermined rotation direction, the motor unit 10 can be aware that the motor M is in a wrong rotation direction state. Thus, the motor unit 10 may judge whether the rotation direction of the motor M is correct or not based on left-right asymmetry characteristics of a back electromotive force signal.

According to one embodiment of the present invention, the motor unit 10 may be applied to a sensorless motor. Also, the motor unit 10 may be applied to a single-phase motor. The motor unit 10 utilizes left-right asymmetry characteristics of the first voltage signal VO1 to judge whether the motor M is in a forward rotation state or not.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor unit comprising:
a switch circuit, comprising a first terminal and a second terminal, wherein the switch circuit is coupled to a motor for driving the motor, the first terminal has a first voltage signal, and the second terminal has a second voltage signal; and
a control unit, configured to generate a plurality of control signals to control the switch circuit, wherein when the first terminal is in a floating state, the motor unit utilizes left-right asymmetry characteristics of the first voltage signal to judge whether the motor is operated in a forward rotation state or not.

2. The motor unit of claim 1, wherein the motor unit further comprises the motor, the motor comprises a rotor, a silicon steel plate, and a coil, and the silicon steel plate has an asymmetrical structure.

3. The motor unit of claim 2, wherein the rotor is divided into four magnetic poles to switch phases.

4. The motor unit of claim 2, wherein the silicon steel plate comprises a first pole body and a first pole shoe, the first pole shoe is coupled to a terminal of the first pole body, and the first pole shoe forms an asymmetrical shape.

5. The motor unit of claim 4, wherein the first pole shoe forms an ax shape, and the ax shape is an asymmetrical pattern.

6. The motor unit of claim 4, wherein the silicon steel plate further comprises a second pole body, a third pole body, a fourth pole body, a second pole shoe, a third pole shoe, and a fourth pole shoe, the second pole shoe is coupled to a terminal of the second pole body, the third pole shoe is coupled to a terminal of the third pole body, and the fourth pole shoe is coupled to a terminal of the fourth pole body.

7. The motor unit of claim 6, wherein the coil surrounds the first pole body, the second pole body, the third pole body, and the fourth pole body.

8. The motor unit of claim 1, wherein the motor unit further comprises a detecting unit, and the detecting unit is coupled to the first terminal and the second terminal for detecting the first voltage signal and the second voltage signal, so as to generate a detecting signal to the control unit.

9. The motor unit of claim 8, wherein the detecting unit generates the detecting signal to inform the control unit that the motor is in the forward rotation state or a reverse rotation state by detecting the first voltage signal.

10. The motor unit of claim 1, wherein the first voltage signal has a right-side slope and a left-side slope, and when the motor is operated in the forward rotation state, an absolute value of the right-side slope is greater than an absolute value of the left-side slope.

11. The motor unit of claim 1, wherein the first voltage signal has a right-side slope and a left-side slope, and when the motor is operated in a reverse rotation state, an absolute value of the right-side slope is less than an absolute value of the left-side slope.

12. The motor unit of claim 1, wherein the first voltage signal has a right-side area and a left-side area, and when the motor is operated in the forward rotation state, the right-side area is greater than the left-side area.

13. The motor unit of claim 1, wherein the first voltage signal has a right-side area and a left-side area, and when the motor is operated in a reverse rotation state, the right-side area is less than the left-side area.

14. The motor unit of claim 1, wherein the motor unit is applied to a sensorless motor.

15. The motor unit of claim 1, wherein the motor unit is applied to a single-phase motor.

16. The motor unit of claim 1, wherein the motor unit judges whether a rotation direction of the motor is correct or not based on left-right asymmetry characteristics of a back electromotive force signal.

17. The motor unit of claim 1, wherein the switch circuit further comprises:
a first transistor, coupled to a voltage source and the first terminal;
a second transistor, coupled to the first terminal and a ground;
a third transistor, coupled to the voltage source and the second terminal; and
a fourth transistor, coupled to the second terminal and the ground.
